(19) United States
(12) Patent Application Publication
(10) Pub. No.: US 2012/0043917 A1
(43) Pub. Date: Feb. 23, 2012

(54) Battery Connection System

(75) Inventor: Alan Riach, West Lothian (GB)

(73) Assignee: TENNANT N.V., AB Uden (NL)

(21) Appl. No.: 13/139,772

(22) PCT Filed: Dec. 14, 2009
(86) PCT No.: PCT/EP09/67071

§ 371 Date: Nov. 8, 2011

(30) Foreign Application Priority Data
Dec. 15, 2008 (GB) 0822781.1

(51) Int. Cl. B60L 11/18

(52) U.S. Cl. 318/139

(57) ABSTRACT

A method of operating an electric vehicle including the steps of: (1) providing the electric vehicle (2) providing an electric load device on the electric vehicle (3) providing a first battery on the electric vehicle with a first state of charge (4) providing a second battery on the electric vehicle with a second state of charge lower than the first state of charge (5) determining an initial state of charge of the first battery (6) determining an initial state of charge of the second battery (7) connecting the first battery to the electric load device (8) measuring the current flow from the first battery (9) calculating an instantaneous state of charge of the first battery (10) comparing the instantaneous state of charge of the first battery with the initial state of charge of the second battery, and (11) when the instantaneous state of charge of the first battery reaches a predetermined percentage of the initial state of charge of the second battery, connecting the second battery in parallel with the first battery.

The present invention relates to a method for connecting two batteries in parallel with a load, in particular two batteries which are mounted on a vehicle and which supply power to propel the vehicle and to perform other functions of the vehicle.

In particular the vehicle may be a cleaning machine.

Cleaning machines, in particular road cleaning machines, or road sweeping machines are known. The term “road cleaning” and “road sweeping” are used broadly to include cleaning and sweeping of other areas such as pedestrian precincts, footpaths, car parks etc. Road cleaning machines are machines for lifting dirt off the road and into a hopper. Road sweeping machines are road cleaning machines that are designed to brush the dirt off the road, generally towards or into a hopper. In many a road sweeping machines a suction pipe (or hose) along with a ground following suction nozzle is provided for sucking swept dirt from the road, and to act as a conduit for passing such dirt up into a hopper. A road cleaning machine can, however, just comprise a suction pipe and the hopper, i.e. no sweeping mechanism. A cab is provided for the operator at the front of the vehicle so as to give a good view of the area to be swept.

An internal combustion engine provides motor power and also power to drive the brushes, suction fan and other devices.

### SUMMARY OF INVENTION

Rather than using an internal combustion engine, batteries can be used to power the vehicle.

For the avoidance of doubt, the term “battery” means a single electric cell, or a plurality of electric cells connected in series.

When it is required to connect two or more batteries in parallel with a load, then the state of charge of the two batteries must be the same otherwise damage to either battery or both batteries may occur. Thus, if a first battery has a higher state of charge than a second battery and both batteries are connected in parallel then current will flow from the battery having a higher state of charge into the battery having a lower state of charge in a violent and uncontrolled way. This runs the risk of causing damage to either of the batteries and also causing damage to the interconnecting circuitry.

There is therefore a requirement for connecting two batteries in parallel in a safe manner that will not cause damage to any of the batteries or associated components.

Thus, according to the present invention there is provided a method of operating an electric vehicle including the steps of:
(1) providing the electric vehicle
(2) providing an electric load device on the electric vehicle
(3) providing a first battery on the electric vehicle with a first state of charge
(4) providing a second battery on the electric vehicle with a second state of charge lower than the first state of charge
(5) determining an initial state of charge of the first battery
(6) determining an initial state of charge of the second battery
(7) connecting the first battery to the electric load device
(8) measuring the current flow from the first battery
(9) calculating an instantaneous state of charge of the first battery
(10) comparing the instantaneous state of charge of the first battery with the initial state of charge of the second battery, and
(11) when the instantaneous state of charge of the first battery reaches a predetermined percentage of the initial state of charge of the second battery, connecting the second battery in parallel with the first battery.

Advantageously, when such a method is used with battery powered vehicles that are used for shift work and require a fresh set of batteries at the beginning of each shift, the fresh batteries can be mounted on the vehicle and connected in a safe manner.

The invention will now be described, by way of example only, with reference to the accompanying drawings in which:—

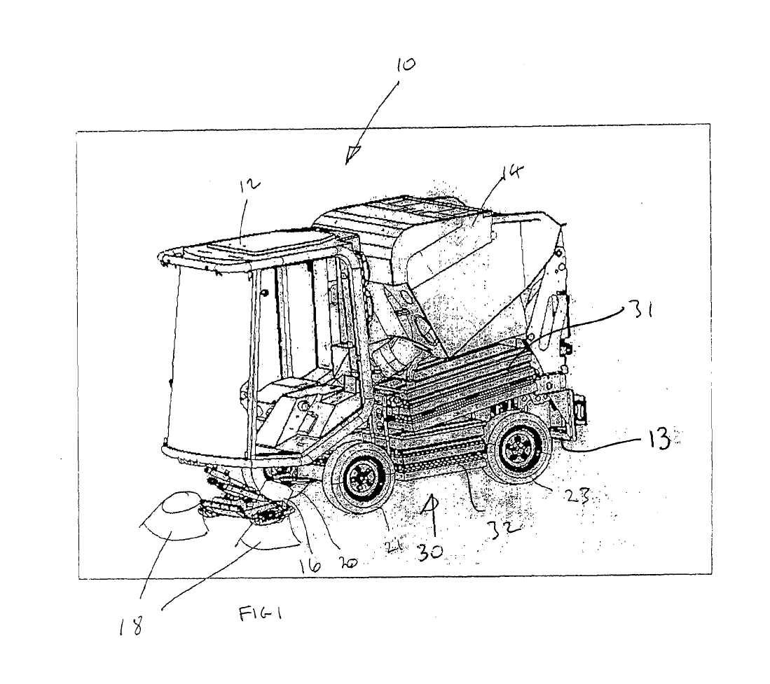

FIG. 1 is an isometric view of a cleaning machine operated in accordance with the present invention, and

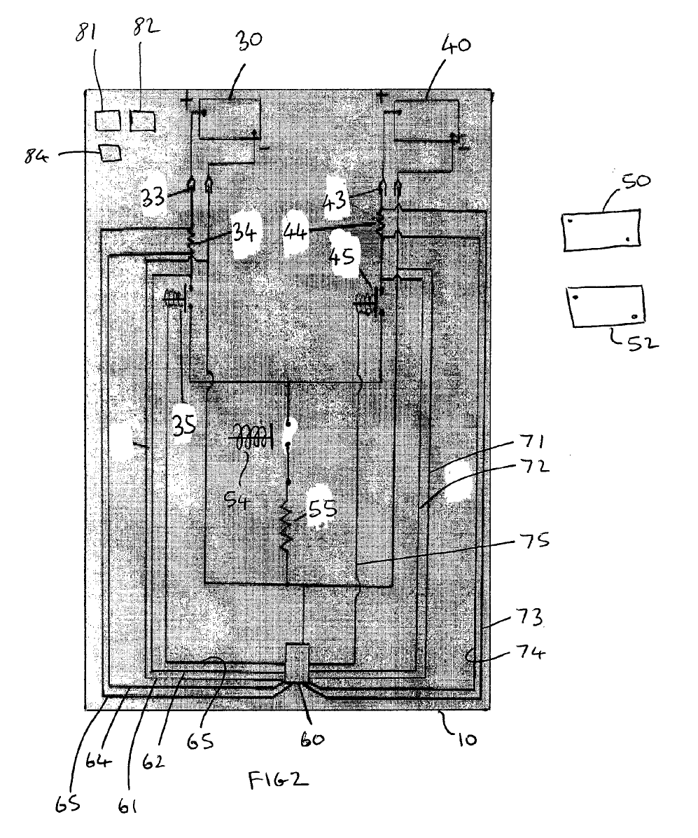

FIG. 2 is a circuit diagram of part of the cleaning machine of FIG. 1.

With reference to FIG. 1 there is shown a cleaning machine, in this case a sweeping machine 10. The sweeping machine includes an enclosed cab 12, a hopper 14, a suction nozzle 16 and brushes 18. The sweeping machine includes a front right wheel 20, a front left wheel 21, a rear right wheel (not shown) and a rear left wheel 23. The wheels support a chassis 13. The front wheels are steerably mounted on the chassis and the rear wheels are non-steerably mounted on the chassis.

The rear wheels can be selectively driven in a forward or reverse direction by an electric motor 55 (situated between the rear wheels (not shown on FIG. 1 but see FIG. 2)). The brushes can be selectively driven by another electric motor (not shown). A fan (not shown) which acts to suck dirt through such a nozzle 16 is driven by a further electric motor (not shown).

Mounted on the left of the vehicle is a first battery pack 30 having an upper compartment 31 and a lower compartment 32. The upper compartment contains a total of fourteen electric cells and the lower compartment contains a total of nine electric cells. The battery pack therefore contains a total of twenty three electric cells. These electric cells are all connected in series with each other. Electric cells are lithium ion cells which each produce a nominal voltage of 3.2 volts, the first battery pack therefore providing a nominal voltage of 73.6 volts. The first battery pack 30 constitutes a first battery according to the present invention (see especially FIG. 2).

Mounted on the right side of the vehicle is a second battery pack which constitutes a second battery according to the present invention. The second battery pack 40 is similar to the first battery pack 30 in as much as it includes an upper compartment with fourteen lithium ion cells and a lower compartment with nine lithium iron cells, all twenty three cells being connected in series to constitute a second battery according to the present invention (see FIG. 2).

It is possible to use the sweeping machine 10 on a shift basis, i.e. a first operator uses the cleaning machine to clean roads etc for a first eight hour shift and then a second operator takes over the cleaning machine ands uses it for a second eight hour shift.

However, the total power available from a fully charged first and second battery pack is only sufficient for a single shift. Thus, at the end of the first shift the depleted first battery 30 and second battery 40 are removed from the vehicle and replaced with a fully charged third battery 50 and fourth battery 52. The third and fourth batteries are identical in construction to the first and second batteries respectively and, being fully charged, will allow the second shift to be completed without running out of power. Whilst second shift is being completed the first and second batteries can be recharged. Upon completion of the second shift the third and fourth batteries can be removed from the cleaning machine and replaced with now fully charged first and second batteries in order to complete a third shift. By utilising the time of the second shift to recharge the first and second batteries ensures that they can be recharged slowly and carefully without damage.

By connecting the first and second batteries in parallel ensures that the operating voltage of the vehicle is 73.6 volts. If the first and second batteries were connected in series, then the operating voltage of the vehicle would need to be 147.2 volts and components, such as motors, operating at these voltages are more expensive than similar motors in components operating at 73.6 volts. Accordingly, by connecting both batteries in parallel, sufficient power can be provided to complete a shift, whilst ensuring that cheaper components operating at a nominal voltage of 73.6 volts can be used.

When the first and second battery packs are connected at the start of the first shift whilst they would nominally both be fully charged, it is almost inevitable that one battery (for the sake of argument the first battery) will have a higher state of charge than the other battery (for the sake of argument the second battery). If these two batteries were connected together then, as described above, damage may ensue.

FIG. 2 shows a circuit that will allow the first and second batteries to be connected. A first circuit associated with the first battery can be defined as follows:—

Starting from the positive terminal of the first battery 30, it is connected via a plug and socket fitting 33 to one side of a shunt resistor 34. The other side of the shunt resistor 34 is connected to one side of a switch 35. The other side of the switch 35 is connected to one side of a motor starter switch 54. The other side of the motor starter switch 54 is connected to a motor 55. The other side of the motor 55 is connected via the plug and socket kit fitting 33 to the negative terminal of the first battery pack.

A computer 60 has sensing wires 61 and 62 which sense the voltage across the terminals of battery 30. The computer also is connected to sensing wires 63 and 64 enabling the computer to detect the voltage drop across the shunt resistor 34. The computer 60 is also connected to the switch 35 via wire 65.

Components 33, 34, 35, 61, 62, 63, 64 and 65 have equivalent features in respect of the second battery 40 as shown at 43, 44, 45, 71, 72, 73, 74 and 75 respectively.

A second circuit associated with the second battery is defined by components 43, 44, 45, 54, 55 and associated wiring.

The method of connecting the first and second batteries to the cleaning machine 10 is as follows.

It is assumed that the first and second batteries 30 and 40 are both nominally fully charged. Both batteries are electrically disconnected from the cleaning machine and are physically disconnected from the cleaning machine, i.e. both batteries have been demounted from the cleaning machine. As an initial step, the first battery 30 is mounted on the left hand side of the vehicle as shown in FIG. 1 and the second battery 40 is mounted on the right hand side of the vehicle.

Note from FIG. 2 that switches 35, 45 and 54 are all open.

The first battery 30 is electrically connected via the plug and socket fitting 33 to the first circuit and the second battery 40 is electrically connected by a plug and socket fitting 43 to the second circuit. At this stage the first and second batteries are not under any load, i.e. no current is flowing. The sensing wires 61 and 62 allow the computer to determine the state of charge of the first battery 30. This is done by sensing the no load voltage across the battery terminals of battery 30. Similarly, the computer 60 can determine the state of charge of the second battery 40 by measuring the no load voltage across its terminals via sensing wires 71 and 72.

The computer can then determine which of the first and second batteries has a higher state of charge, and by how much. For the sake of the present example, it is assumed that first battery pack 30 has a higher state of charge than the second battery pack 40. Once the computer has made this determination, then the switch 35 or 45 associated with the battery having the higher state of charge is closed, in this example switch 35 is closed. At this stage, because switch 54 is still open, no electric load is applied to the battery 30. When it is required to use the vehicle, then motor 55 will be started by closing switch 54 thereby propelling the vehicle. As soon as switch 54 is closed a voltage drop will appear across the terminals of the shunt resistor 34 which voltage drop can be measured by the computer via wires 63 and 64. The computer can then determine (by knowing the value of the shunt resistance) the instantaneous current being drawn from the first battery 30. The state of charge in battery 30 will start to fall and the computer can calculate the instantaneous (or ongoing) state of charge of the first battery by measuring the amount of current flowing from the battery. The computer can then compare the instantaneous state of charge of the first battery with the initial state of charge of the second battery. When the instantaneous state of charge of the first battery reaches a predetermined percentage of the initial state of charge of the second battery then the second battery can be connected in parallel with the first battery by closing switch 45. Preferably, switch 45 is closed when the state of charge of the first battery reaches 100% of the initial state of charge of the second battery. Under these circumstances the state of charge of both batteries is identical and therefore connecting both batteries in parallel does not cause any damage to either the batteries or the associated circuitry.

Whilst ideally the state of charge of both batteries is identical when they are connected, clearly small variations in the state of charge of the batteries can be accommodated without causing damage to either the batteries or the associated circuitry. Thus the predetermined percentage might be between 100.1% and 99.9%. Alternatively the predetermined percentage might be between 100.5% and 99.5%. Alternatively the predetermined percentage might be between 101% and 99%. Alternatively the predetermined percentage might be between 105% and 95%.

As shown in FIG. 2, all components other than the third battery 50 and fourth battery 52 are mounted on the vehicle. As such, as soon as the batteries 30 and 40 are mounted on the vehicle and have been electrically connected and as soon as the computer has determined which of batteries 30 or 40 has the higher state of charge and has closed the appropriate switch 35 or 45, then the vehicle can be used and as such the turn around time between shifts is minimised.

It will be appreciated that in the event that the second battery 40 has a higher state of charge than the first battery 30, then switch 45 will be closed in preference to switch 35, and switch 35 will only be closed when the instantaneous state of charge of battery 40 is determined to have fallen to a predetermined percentage of the initial state of charge of battery 30.

When the vehicle 10 as shown in FIG. 2 is being used and is being powered by first battery 30 and second battery 40, the third battery 50 and fourth battery 52 can be recharged. At the end of the first shift the first and second batteries can be electrically disconnected and physically demounted from the vehicle 10 and can be replaced by the third battery 50 and a fourth battery 52 respectively. The manner in which the third and fourth batteries are then connected to the load is as described for connecting the first and second batteries. Whilst the vehicle is being used with the third and fourth batteries, the first and second batteries can be recharged and at the end of the second shift batteries can again be swapped so that the third shift uses the first and second batteries.

Note that by matching the state of charge of batteries whilst they are on the vehicle, it is possible to use the energy required to match the state of charge of both batteries to carry out useful work, in this example to propel the vehicle.

As shown in FIG. 2 the electric load device used to discharge the battery having the higher initial state of charge is the motor 55. Alternatively, other motors or other load devices could be used, such as the motor described above to drive the brushes 18, the motor described above to drive the fan, or any other motor of the vehicle. Additionally, or alternatively, any other electrically powered piece of equipment could be used to drain the battery having the higher initial state of charge. For example various lights commonly found on the vehicle could be used.

As described above, the current flowing from the battery with the initial highest state of charge is calculated by measuring the voltage drop across shunt resistor 34 or 44. In an alternative embodiment, the measurement of current could be carried out by any other suitable means.

Switches 35, 45 and 54 are shown as mechanical switches, i.e. switches wherein contact between terminals is made and broken. Any type of mechanical switch can be used. Furthermore, a type of non-mechanical switch, such as a metal oxide semiconductor field effect transistor (MOSFET) switch could be used.

Advantageously, the switches 35 and 45 can be arranged to be opened upon disconnection of one or other or both of the first and second batteries. For example, where switches 35 and 45 are mechanical switches they can be sprung loaded to an open position and closed by feeding power to an associated solenoid. Once the batteries 30 and 40 have been disconnected then power will no longer be fed to the solenoids and the switches 35 and 45 will automatically spring to the open position.

Advantageously, it is useful to be able to display the state of charge of the first battery and also to be able to display this state of charge of the second battery. Thus, the cleaning machine 10 includes a first display 81 which displays the state of charge of the first battery pack 30 and a second display 82 which displays the state of charge of the second battery pack 40. Preferably the first and second displays are visible to an operator using the cleaning machine, i.e. they are visible to the operator when the cleaning machine is being used for cleaning purposes and during transportation to and from a site to be cleaned. Typically the displays 81 and 82 will be in the cab 12. Typically each display will display the state of charge of the associated battery in terms of a fraction of the maximum state of charge of the battery. The displays can be likened to information given by fuel gages on automobiles and the like. A full state of charge equates to the energy capacity (or fuel capacity) of the vehicle being “full”. When the state of charge of the battery reduces to a predetermined level (not necessarily a zero state of charge) the display can indicate “empty”. The display can be via a rotating needle. Alternatively the display may be colour coded, green indicating a relatively high state of charge and red indicating a relatively low state of charge.

Advantageously, by providing displays, one for each battery pack, an indication of the total electrical energy available is given. Furthermore, under normal circumstances, once both batteries have been connected in parallel, the operator would normally expect the state of charge of each battery to reduce at the same rate, and hence the displays to indicate approximately the same amount of state of charge for each battery. In the event that one display indicated a different state of charge to the other, then this is an indication to the operator that there is a fault in the system.

Having two displays can also help to detect improper maintenance. For example, at the end of the shift, the first and second battery packs will be removed and, under normal circumstances will be replaced with fully charged third and fourth battery packs. However inadvertently, the wrong battery may be replaced, for example once the first and second batteries have been removed, the operator may inadvertently muddle up the third battery with a first battery and then replace the first battery on the vehicle. If the operator then correctly replaces the fourth battery onto the vehicle the display 81 will display a low state of charge whereas the display 82 will display a high state of charge. A significant difference in the state of charge displayed by displays 81 and 82 once the batteries have been replaced indicates a problem. Advantageously, when the state of charge of the two battery packs on the vehicle differs by more than a predetermined amount, for example where the state of charge of the two batteries differs by more than 10% then a warning device 84 can be arranged to indicate this to the operator. Preferably the warning device 84 is a light, and preferably the light is visible to the operator when operating the vehicle e.g. when seated in the cab. Alternatively, or additionally, the warning device 84 could be an audible warning device such as a buzzer and preferably the audible warning device is audible by the operator when operating the vehicle e.g. when seated in the cab.

1.-14. (canceled)

15. A method of operating an electric vehicle comprising the steps of:
(a) providing the electric vehicle;
(b) providing an electric load device on the electric vehicle;
(c) providing a first battery on the electric vehicle with a first state of charge;
(d) providing a second battery on the electric vehicle with a second state of charge lower than the first state of charge;
(e) determining an initial state of charge of the first battery;
(f) determining an initial state of charge of the second battery;
(g) connecting the first battery to the electric load device;
(h) measuring the current flow from the first battery;
(i) calculating an instantaneous state of charge of the first battery;
(j) comparing the instantaneous state of charge of the first battery with the initial state of charge of the second battery; and
(k) when the instantaneous state of charge of the first battery reaches a predetermined percentage of the initial state of charge of the second battery, connecting the second battery in parallel with the first battery.

16. The method of claim 15 wherein step e comprises measuring the voltage of the first battery and step f comprises measuring the voltage of the second battery.

17. The method of claim 16 further comprising providing a computer on the electric vehicle, wherein one or more of steps e, f, g, h, i, j and k is carried out by the computer.

18. The method of claim 15 further comprising providing a computer on the electric vehicle, wherein one or more of steps e, f, g, h, i, j and k is carried out by the computer.

19. The method of claim 15 wherein the electric load device is a motor.

20. The method of claim 15 further comprising the steps of:
(l) providing a first circuit on the electric vehicle with a first switch in an open position;
(m) providing a second circuit on the electric vehicle with a second switch in an open position;
(n) connecting the first battery to the first circuit; and
(o) connecting the second battery to the second circuit;
wherein step g comprises closing the first switch and wherein step k comprises closing the second switch.

21. The method of claim 20 wherein step e comprises measuring the voltage of the first battery and step f comprises measuring the voltage of the second battery.

22. The method of claim 20 further comprising providing a computer on the electric vehicle, wherein one or more of steps e, f, g, h, i, j and k is carried out by the computer.

23. The method of claim 22 wherein step g is carried out upon receipt of a signal from the computer and/or step k is carried out upon receipt of a signal from the computer.

24. The method of claim 20 wherein the electric load device is a motor.

25. The method of claim 24 wherein the motor operates to propel the vehicle and/or to drive a fan on the vehicle and/or to drive a brush of the vehicle.

26. The method of claim 20 wherein an instantaneous state of charge of the first battery is displayed on a first display and an instantaneous state of charge of the second battery is displayed on a second display.

27. The method of claim 20 wherein if the initial state of charge of the first battery differs from the initial state of charge of the second battery by more than a predetermined amount a warning device provides a warning.

28. The method of claim 15 wherein the electric load device of step b comprises a motor and wherein the first and second batteries are mounted to the vehicle in steps c and d, further comprising:
at least partially depleting the first and second batteries after step k;
then disconnecting the first and second batteries and demounting them from the electric vehicle;
and then providing a third and fourth battery, mounting the third and fourth batteries on the electric vehicle in place of the first and second batteries, and connecting the third and fourth batteries in parallel with the load.

29. The method of claim 28 in which all steps are carried out within a 24 hour period.

30. The method of claim 15 wherein an instantaneous state of charge of the first battery is displayed on a first display and an instantaneous state of charge of the second battery is displayed on a second display.

31. The method of claim 30 wherein the instantaneous state of charge of the first battery is displayed in terms of a fraction of a maximum state of charge of the first battery and/or the instantaneous state of charge of the second battery is displayed in terms of a fraction of a maximum state of charge of the second battery.

32. The method of claim 31 wherein the first and second displays are visible to an operator when operating the electric vehicle.

33. The method of claim 15 wherein if the initial state of charge of the first battery differs from the initial state of charge of the second battery by more than a predetermined amount a warning device provides a warning.

34. The method of claim 33 wherein the warning device is visible and/or audible to an operator when operating the electric vehicle.
